(19) United States
(12) Patent Application Publication
(10) Pub. No.: US 2010/0173816 A1
(43) Pub. Date: Jul. 8, 2010

(54) Microorganism Reduction Methods and Compositions for Food with Controlled Foam Generation

(76) Inventor: Todd Wichmann, Loveland, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/601,478

(22) PCT Filed: May 23, 2008
(86) PCT No.: PCT/US08/64619

§ 371 Date: Nov. 23, 2009

Related U.S. Application Data
(60) Provisional application No. 60/931,835, filed on May 25, 2007.

(51) Int. Cl. C11D 1/12

(52) U.S. Cl. 510/111; 510/276

(57) ABSTRACT

Acid cleaning compositions using toxicologically-acceptable ingredients for treating food such as produce, e.g., fruits and vegetables, and edible animal proteins are provided. Liquid formulations comprising, optionaly, from about 0.5% to about 6% of anionic surfactant, such as sodium alkyl sulfates; a silicone containing suds suppresser and polysorbate that deliver suds control benefits, anionic surfactant long term stability and microorganism reduction.

### FIELD OF THE INVENTION

Acid cleaning compositions using toxicologically-acceptable ingredients for treating food such as produce, e.g., fruits and vegetables, and edible animal proteins are provided. Liquid formulations comprising, from about 0.5 to about 6 weight percent of anionic surfactant, from about 1 to 6 weight percent hydrophile-lipophile balance solubilizer selected from the group of sorbitan esters and polysorbates and mixture of thereof, and 0.1 to 5 weight percent of foam suppresser agents selected from the group of pluronics, silicone containing molecules and polysorbates to deliver foam control capability under high shear environment preventing high foam or suds generation that would otherwise prevent industrial processability or immediate individual consumption without rinsing. The compositions are formulated with an acid buffer to prevent hydrolysis of the surfactant maximizing such surfactant efficacy and shelf life. The methods and compositions are intended for both, industrial and individual or retail applications.

### BACKGROUND OF THE INVENTION

Fruits and vegetables, and sometimes other food products such as meats, are desirably washed prior to ingestion in order to remove soils and other unwanted residues which may be undesirably clinging to the surfaces thereof. However, usual cleaning process used by individual consumers, institutions, and the food processing industry may not provide sufficient antimicrobial action for making fruits, vegetables and meat products safe to eat and palatable under conditions when an abundant source of safe water is not available for rinsing or when the formulation used for the cleaning process are not desirable for use in direct contact with foods where they are not completely removed by a rinsing step. Furthermore, many art-disclosed cleaning formulations that deliver the beforehand mentioned benefits usually contain surface active agents which generate high levels of suds or foam that may affect the process ability under industrial or institutional applications or the palatability and aftertaste in individual consumer applications. Such formulations may benefit from the addition of foam reduction agents. The design of foam controlled formulation presents a unique problem to the formulator, inasmuch as many art-disclosed foam reduction agents would not be desirable for use in direct contact with foods or may not deliver the necessary efficiency or long term stability under the necessary surface active agent level required to provide sufficient antimicrobial action. In addition, the design of such formulation are particularly challenging when formulated at low pH or acidic conditions in liquid form due to the chemical and physical instability of foam reduction agents at these conditions.

Moreover, it would be especially desirable to provide effective, toxicologically-acceptable compositions for food, including fruits and vegetables and/or meats that can be sold in concentrated form and used to create dilute low-sudsing liquid solutions which are clear or which have only minimal haziness and which can be used to effect antimicrobial action and which provide palatable food without removal. Dilute liquid solutions are convenient for the user, since they can be applied directly to soiled fruits and vegetables by simple immersion, thus ensuring that all parts of the food are treated. Clarity of the dilute liquids connotes cleanliness to the user and is thus highly desirable. Low sudsing is an important attribute so that the elimination of any suds is achieved quickly and easily. It is also of advantage if such concentrates can be diluted by the consumer using water that is not safe for use, since that is sometimes the only water that is available.

Furthermore, it is known to an individual skilled in the process of handling and treating food products the wide variety of conditions that a formulation for treating food product may encounter during both industrial and individual application. For example, on some applications the task may be to remove the artificial hydrophobic coatings such as waxes, oils, or man-made chemical residues such as pesticides, which may be applied to some fruits to retard moisture loss for increased storage life and to enhance their appearance. In other applications, it may be desired to remove dirt or soil or other types particulate insoluble soils that do not readily disperse in water from the surface of the treated product. Moreover, in the particular application of treating meats the challenge is dealing with blood and other biological secretions which introduce proteins to the resultant process solution. It is recognized these task can be accomplished by the use of surface active ingredients. However, each one of these uses generate a different resultant solution and suds profile, i.e., hydrophobic, soiled and protein containing solutions each will have different suds characteristic with respect to draining, air interface stability and bubble size, each presenting a different challenge for the formulator. It would be of especial interest to formulate liquid formulation which is capable to control sudsing generated from either application by being able to reduce sudsing using multiple mode of action.

Unfortunately, many toxicologically-acceptable cleaning ingredients do not meet the aforesaid requirements for clear, low-sudsing, dilutable liquid products that are in addition able to control sudsing from multiple sources. In addition, many detersive surfactants form cloudy or even opaque suspensions in water. Of course, many surfactants are specifically designed to be high sudsing. Still others form relatively intractable phases in their concentrated form.

### SUMMARY OF THE INVENTION

The present invention encompasses methods for treating food, including produce, especially fruits and vegetables, and meats (and compositions, as disclosed hereinafter, for practicing said methods) at a acid pH, especially without rinsing, while maintaining palatability. In its broadest aspect, it comprises a method for treating food to reduce the level of microorganisms, said treatment occurring just prior to consumption, comprising the step of contacting the surface of said food with an aqueous treatment composition comprising: optionally, anionic surfactant; and acidic buffer to provide a pH of between about 2.9 to about 3.0 for a period of time in excess of about one half of a minute, the composition being essentially free of any material that adversely affects palatability, wherein said food does not need to be rinsed before consumption and the composition also offering suds control benefits and anionic surfactant stability.

The present invention comprises several more specific aspects including:

I. A method for making food, including produce and meat, safe to eat comprising contacting the surfaces of said food, shortly before ingestion so as to minimize the chances for recontamination, by direct application of a dilute aqueous treatment composition having a pH above about 10.5, typically comprising:
(a) from about 0.4% to about 6% by weight of toxicologically-acceptable detergent surfactant selected from the group consisting of alkyl sulfates;
(b) a acid buffer to provide a pH in said dilute treatment composition of from about 2.9 to about 3.1, but with low reserve acidity in said dilute composition to avoid damage to a human;
(c) from about 0.5% to about 5%, by weight of a polysorbate;
(d) a toxicologically-acceptable suds suppressor; and
(e) the balance comprising compatible, toxicologically-acceptable inert and/or minor ingredients, said composition being packaged in combination with usage instructions which instruct the user regarding dilution and timing of useage of said composition, as well as directing the user not to rinse the composition from the food to avoid possible recontamination, wherein said timing of useage comprises contacting said food with said dilute treatment composition for a period of time in excess of one half minute.

The inventions disclosed herein preferably encompass concentrated compositions suitable for use in preparing such dilute compositions for treating food at a acid pH from about 2.9 to about 3.2, by diluting with water using from about 0.1% to about 5%, preferably from about 0.5% to about 2%, of the concentrated composition, by weight of the dilute composition, said concentrated composition comprising:

(a) from about 0.4% to about 6% , preferably from about 0.5% to about 4%, and more preferably from about 1% to about 2%, by weight of toxicologically-acceptable anionic surfactant, preferably acid-stable anionic surfactant, and more preferably, a alkyl sulfates;

(b) toxicologically-acceptable acid buffer, preferably potassium and/or sodium citrate, but with low reserve acidity in said dilute composition to avoid damage to a human;

(c) toxicologically-acceptable suds suppresser;

(c) toxicologically-acceptable suds polysorbate; and

(f) the balance comprising compatible, toxicologically-acceptable inert and/or minor ingredients.

In all of the above lists of components, if an ingredient can be classified in more than one place, it will be classified in the first place it can appear. Preferably all ingredients are food grade, since they may be ingested.

A more specific method for preparing food, especially produce such as fruits and vegetables involves exposing the food to a dilute aqueous solution having a acid pH, for a period of time of more than about one half of a minute, said aqueous cleaning solution.

An acidid method for treating food comprises contacting the surfaces of produce with an aqueous solution prepared by creating a solution having a pH of from about 2.9 to about 3.2, using the concentrated composition above and impure water, to provide pure solutions that kill microorganisms on the surface of food.

Another preferred variation in the above methods for treating food such as produce involves placing concentrated compositions, as disclosed herein, into containers in association with instructions to use the composition to form said dilute solutions to treat food. Such instructions are very important, since the amount of dilution, the time of treatment, the elimination of the need for rinsing, and the ability to use impure water to form the treatment solution are not intuitive. It is also important that the instructions be as simple and clear as possible, so that using pictures and/or icons is desirable.

The balance of the composition can comprise various optional adjunct materials, pH-adjusting agents, perfumes or essences, preservatives, suds suppressors, and the like.

The ingredients in the above concentrated compositions are preferably “food grade” and selected and used in proportions which provide substantially clear dilute compositions. “Substantially clear” includes only minimal haziness, and preferably the compositions are completely clear. The ingredients are also selected to have minimal odor, both initially and after storage. The lack of odor is especially important in compositions for use on food.

In order to mask any objectionable odor, the compositions can contain a food grade or GRAS (defined hereinafter) perfume, or essence, ingredient. Especially preferred for this use are oils derived from citrus fruit, e.g., oranges, lemons, limes, grapefruits, tangerines, tangelos, etc. which contain relatively large amounts of terpenes.

Preferred compositions for use herein contain only materials that are food grade or GRAS, including, of course, direct food additives affirmed as GRAS, to protect against possible misuse by the consumer. Traditionally, most suggestions for cleaning of fruits and/or vegetables have contemplated a commercial scale where there is typically more control over the conditions, especially the amount and thoroughness of rinsing. The present invention includes use by individual consumers without rinsing, so that it is essential that extra safety be built into the product. Failure to rinse thoroughly after cleaning is less of a concern if all of the ingredients are GRAS and/or food grade.

The use and selection of cleaning ingredients for the purpose of washing fruits and vegetables is described by the United States Code of Federal Regulations, Title 21, Section 173.315: “Ingredients for use in washing or lye peeling of fruits and vegetables”. These regulations restrict the ingredients that may be used for direct contact with food to those described as “generally regarded as safe” (GRAS), and a few other selected ingredients. These sections also provide certain limitations on the amount of material that can be used in a given context. However, there are no regulations, or suggestions, for methods of making food safe for consumption using aqueous compositions that do not need to be removed. Also, there is no known method for killing microbes using materials like hypochlorite, iodine, etc. at low levels that provide desirable palatability.

All documents cited herein are incorporated herein by reference.

### DETAILED DESCRIPTION OF THE INVENTION

The following toxicologically-acceptable ingredients are used in the preparation of the preferred compositions herein. By “toxicologically-acceptable” is meant that any residues from the ingredients of the compositions which may remain on the fruits or vegetables cleansed therewith are safe for ingestion by humans and/or lower animals.

### Synthetic Anionic Surfactant

Acid stable anionic surfactants can be employed, e.g., as allowed in the United States by the United States Code of Federal Regulations (CFR), Title 21, Section 173.315. Specific mention is made of Sodium Lauryl Sulfate, from herein describe by SLS, from levels of 0.4% to up to levels of 6%. Also described in the CFR are phosphate esters of ethylene and/or ethylene/propylene oxide adducts of aliphatic alcohols, dioctyl sulfosuccinate, or 2-ethylhexyl sulfate, but these materials exhibit lower stability at acid conditions.

The anionic surfactant is preferably selected from materials known in the art, such as C 6-18alkyl sulfates and/or sulfonates; C 6-15alkylbenzene sulfonates; di-C 6-10alkyl sulfosuccinates, etc. The alkyl sulfates are preferred, for antimicrobial effectiveness and palatability, especially as the sodium and/or potassium salts.

In particular SLS is important for its superior ability to reduce the surface tension of the solution even under acidic conditions. This is primary a result of its low critical micelle concentration, or CMC, that allows high monomer concentration in solution. The surfactant is also critical in reducing the viscosity of the dilute solution. It is highly desirable that the dilute treatment compositions have a low viscosity, typically less than about 10, preferably less than about 5, and more preferably less than about 1. The low viscosity improves the completeness of the treatment by promoting spreading over the surface of the food, especially where there are layers, rugosities, etc. The low viscosity also improves drainage, thus providing at least some soil removal. Low viscosity also improves speed of drying, if that is desired. Thus, the detergent surfactant provides highly important advantages in terms of treatment.

The detergent surfactant also improves antimicrobial action. The presence of the surfactant, and especially the alkyl sulfate, provides improved kill and/or rate of germ removal.

### Nonionic Surfactant

The nonionic surfactant is preferably selected from materials known well-known in the art, such as polysorbates and sorbitant. The preferred polysorbate has a hydrophilic-lipophilic balance (HLB) greater than about 10, and a cloud point above about 35° C. The preferred sorbitant has a HLB lower than 9. Without being limiting by theory, it was found that the polysorbate assisted the primary suds suppresser component in particular when the foam contained or was generated from a wax or protein containing solution. The sorbitant is added to improve the physical stability of the suds suppresser component when the suds suppresser component is a silicone containing molecule. Both polysorbates and sorbitant are GRAS on the CFR. In addition, the polysorbate functions to provide a cleansing action on protein containing systems, it is in particular effective in removing blood from meat products. The preferred polysorbates are polysorbate 80 and 81, with polysorbate 60, 40 and 20 also considered acceptable. For the sorbitant the preferred materials are Sorbitant laurate and Sorbitant Stearate, also known as Sorbitant 20 and 60.

### Acidic Buffer

Toxicologically-acceptable acidic buffers are used in the compositions herein to maintain product pH in the desired range. Both sodium and potassium salts are acceptable. Sodium and potassium hydroxides can be used as part of acidic buffer systems. The levels and identities of the ingredients are adjusted to provide products having a neat pH of between 2.3 to 2.6. In the preferred embodiment, the formulation is buffered around the pKa of citric acid, approximately 2.5 pH. In this buffered region improved SLS stability is observed. This is a surprising result, since at low pH hydrolysis of the SLS was expected.

### Fluid Carrier

The major proportion, e.g., more than about fifty percent, (typically, approximately 60-80%, by weight) of the neat compositions herein comprises water as the solubilizing carrier for the ingredients. As noted in the Examples hereinafter, water-ethanol can also be employed and is especially preferred when formulating the acid pH compositions herein. The ethanol level in the neat composition preferably should not exceed 6% to avoid an alcoholic odor. Other compatible, water-soluble, low molecular weight solvents such as glycerol can also be used. It is an advantage of this invention is that one can use impure water to prepare the dilute composition, the microorganisms being killed by the low pH and/or surfactant and/or acidic buffer region. As used herein, “impure water” is water that is impure by reason of microorganisms being present.

Suds suppressors. (Silicones and their derivatives) At low levels, suds suppressors or antifoamers can be used, especially in the case where a certain surfactant level is desired for wetting and/or efficacy, but the degree of foam generated in the washing of produce is desired to be kept low. The amount of suds suppresser can be tailored in conjunction with the type and level of surfactant used. DC-10 and DC 13F 20 from Dow Coming and SE 39 and SE 90 from Wacker are useful suds suppressors.

The Polysorbates, previously discussed, can be used to improve the solubility of the a silicone suds suppresser particle.

Mild fragrances. Odor ingredients can be useful at low levels in concentrates. They can give a concentrate a favorable odor, but under dilution are not noticeable in solution or on treated items.

### Usage

The concentrated compositions herein are preferably used by placing them in a container, such as a pan, with water, preferably pure, to form the dilute compositions and facilitate immersion of the food.

The typical use involves treating individual items of food in a “bath” followed by draining the food and/or drying, to minimize the amount of composition left on the food.

In another optional process, potentially impure water is treated with the concentrated composition to kill microorganisms and this “treated” water is used to rinse food that has been treated with the dilute treatment composition in another vessel. This protects against the undetected gradual contamination of the original treatment composition. The “rinse” composition can contain lower levels of the concentrate, since all that is needed is to kill the microorganisms in the water itself.

Surprisingly, the compositions and processes described herein can provide effective disinfectancy/sanitization. In order to provide good kill of microorganisms, especially bacteria, one should maintain the recommended dosage of 1 oz per gallon or about 10 g per liter. The use high concentrations and/or longer exposure times will further improve kill of microorganisms. Typically, the dilute composition should be allowed to remain on the food for at least about one half minute, preferably at least about one minute, and even more preferably at least about five minutes, and, for some microorganisms, even ten minutes may be required. Longer exposure times (i.e., the time that the bacteria are in contact with the product) give better antimicrobial benefits. The importance of time depends both on the pH of the product and on the formula concentration. The overall the kill of microorganisms depends on exposure time, reserve acidity at the dilution pH and on the level of the SLS.

### The Methods

The methods herein can comprise forming the dilute treatment composition using either (a) pure and/or (b) impure water and then either (1) not rinsing so that any removal is by mechanical means, absorption, and/or draining; (2) rinsing with pure water if it is available; and/or (3) treating impure water with the dilute treatment composition to create “pure” rinse water and then rinsing.

### Food

All kinds of foods can be treated. Examples include: produce including fruits and vegetables such as apples, grapes, peaches, potatoes, lettuce, tomatoes, celery, and the like, that are to be eaten after treatment, and edible animal protein, especially meat, seafood and poultry, including foodstuffs which are comprised essentially of the protein found in such foods sources including, but not limited to, beef, pork, chicken, turkey, fish, shellfish and game meats such as venison, rabbit and the like. Said edible animal protein includes the processed forms of said protein sources, including, but not limited to, such forms as ground beef, ground turkey, bologna, hot dogs, sausages, fish cakes, and the like. The food is preferably ready to eat after treatment, and is eaten shortly thereafter to minimize recontamination.

The diluted forms of the compositions can also be used for cleaning (especially spot removal), disinfectancy, or sanitization, on non-food (i.e., any surface which is not used as food, even those which are not in contact with food), inanimate, household surfaces, especially those used in food production and other food-contacting surfaces (surfaces that come in contact with food). E.g., cutting boards, counter tops, utensils, dishes, colanders, sinks, sponges, towels, dish cloths, cloth napkins (serviettes), table cloths, and other surfaces that come in contact with food. It is desirable to disinfect/sanitize before the surfaces come in contact with the food, and is desirable to redisinfect/sanitize whenever the surfaces become recontaminated. The products herein, containing all GRAS and/or food grade ingredients, are perfect for this purpose. On hard surfaces, of course, the compositions can be removed, after sufficient time has elapsed, by rinsing if pure water is available, or by absorption/wiping with an appropriate object, e.g., paper towel, sponge, squeegee, etc.

The diluted forms of the compositions of this invention can also be used to treat/clean other non-food inanimate household surfaces, such as fabrics, e.g., clothing, shoes, and shower curtains, especially those that are used by infants, especially toys, diapers (napkins), and bibs. The contaminated fabrics can be disinfected/sanitized, then allowed to drain and/or dry, while minimizing the risk if the infant puts the fabric or other article in its mouth. However, it is desirable to rinse fabrics, at least with water that contains less alkalinity. The fabric can be treated totally, or by spot treatment, then the composition is preferably removed, at least partially, e.g., by draining, absorbency, and/or mechanical force.

Packaging the products herein in a container with instructions for usage in terms of timing and proper dilution in order to provide disinfectancy/sanitization, will help the individual consumer by providing information for proper usage in order to remove/kill microorganisms. It is a special advantage of the product that it can be used for this purpose at a time in the food production process where recontamination is minimized. The instructions desirably provide assurance that rinsing is not needed in order to avoid possible recontamination by rinsing with impure water.

All parts, percentages, and ratios herein are “by weight” unless otherwise stated. All number values are approximate unless otherwise stated.

The following Examples illustrate the compositions and processes of this invention, but are not intended to be limiting thereof. The exemplified acid liquid dilute treatment compositions can be prepared by dissolving the concentrated compositions in water using conventional mixing apparatus.

The following examples depict the bacteria kill efficacy of the proposed invention as determined by a standard AOAC germicidal and detergent sanitizing test. Test organisms E. coli, ATCC 11229, or Staphylococcus aureus, ATCC 6538, are prepared in an inoculum with a 5% organic soil load (horse serum) prepared with French culture bottles to achieve higher cfu/ml. The test exposure temperature is 25° C. and incubation time for survivor count is 48-54 hours at 35° C. The organisms were exposed to the diluted compositions, neutralized and the log reduction calculated using standard plate counting techniques.

### Examples

The following solutions (A-D) were prepared and tested for efficacy against S. Aureus and E. coli at a solution pH of 3.0+/−0.1. All dilutions delivered significant reductions in counts (>5 log after 1 min).

Solutions

| | A | B | C | D |
|---|---|---|---|---|
| Deionized water | Balance | Balance | Balance | Balance |
| SLS | 1.00 | 1.5 | 3.0 | 4.0 |
| Sodium Hydroxide | 1.75 | 1.75 | 1.75 | 1.75 |
| Citric Acid | 20.36 | 20.36 | 20.36 | 20.36 |
| Polysorbate 80 | 3.00 | 3.00 | 3.00 | 3.00 |
| Grapefruit Oil | 0.03 | 0.03 | 0.03 | 0.03 |
| Ethanol | 2.00 | 2.00 | 2.00 | 2.00 |

Microbial Kill of 10 g per liter diluted solution

| | | | | |
|---|---|---|---|---|
| S. Aureus | 5.45 | 6.00 | 6.00 | 6.20 |
| (log reduction) | | | | |
| E. Coli | 5.45 | 6.10 | 6.52 | 6.99 |
| (log reduction) | | | | |

Produce washed in the soak solution was determined to have no negative effects on it in regards to taste or palatability without a rinse.

Another benefit of the proposed invention is the ability to control suds. The suds control benefit of the invention were tested using a 1000 ml graduated cylinder, which was placed in a rotating apparatus that rotated at 30 rpm. The test solutions were made by diluting 10 g of concentrated formulation in one liter of tap water, 300 ml of this solution was added to the graduated cylinder and the apparatus allowed to rotate for 10 rotations. The suds height was determined by substracting the total height of the suds from the 300 ml of solution. Suds height below 40 ml were considered acceptable.

Under use conditions it may be required to control suds from three different sources, i.e., soil particulate, waxy and protein conditions. To test the effect of formulation components under these conditions, three alternative dilution formulation were made by allowing a liter of the diluted solution of the concentrate to soak for 24 hours with approximately 500 g of potatoes, apples and raw chicken. Without being bound by theory, the potatoes, the apple and the raw chicken solutions represent respectively soil particulate, waxy and protein conditions. The following table shows the suds control benefits under these conditions.

Concentated Compositions

| | E | F | G | H |
|---|---|---|---|---|
| Deionized water | Balance | Balance | Balance | Balance |
| SLS | 1.50 | 1.50 | 1.50 | 1.50 |
| Sodium Hydroxide | 1.75 | 1.75 | 1.75 | 1.75 |
| Citric Acid | 20.36 | 20.36 | 20.36 | 20.36 |
| Polysorbate 80 | — | — | 3.00 | 3.00 |
| Grapefruit Oil | 0.03 | 0.03 | 0.03 | 0.03 |
| Ethanol | 2.00 | 2.00 | 2.00 | 2.00 |
| Suds Suppreser | 0.00 | 0.50 | — | 0.50 |
| Dow BF 20 | | | | |

Suds height performance (mm)

| | | | | |
|---|---|---|---|---|
| Tap water | 120 | 6 | 60 | 0 |
| Soil Particulate Soln | 80 | 0 | 50 | 0 |
| Water from | 120 | 40 | 70 | 10 |
| wax soln | | | | |
| Protein Soln | 90 | 50 | 30 | 6 |

The table shows the synergestic benefit of the suds suppresser in combination with a polysorbate in handling suds from all three solutions.

The following example shows the suds performance for dilutions with tap and wax water, by diluting 10 g of the concentrated liquid product into 1 liter of the tested dilution.

| | Concentated Compositions | | | | | |
|---|---|---|---|---|---|---|
| | I | J | K | L | M | N |
| Deionized | Balance | Balance | Balance | Balance | Balance | Balance |
| water | | | | | | |
| SLS | 1.00 | 1.50 | 1.50 | 3.00 | 4.00 | 4.00 |
| Sodium | 1.75 | 1.75 | 1.75 | 1.75 | 1.75 | 1.75 |
| Hydroxide | | | | | | |
| Citric Acid | 20.36 | 20.36 | 20.36 | 20.36 | 20.36 | 20.36 |
| Polysorbate 80 | — | 3.00 | 3.00 | 1.5 | 3.00 | 3.00 |
| Polysorbate 81 | 3.00 | — | — | — | — | — |
| Sorbitan 20 | — | — | — | — | — | 1.00 |
| Sorbitan 60 | — | 1.00 | 1.00 | — | — | — |
| Grapefruit Oil | 0.03 | 0.03 | 0.03 | 0.03 | 0.03 | 0.03 |
| Ethanol | 4.00 | 4.00 | 4.00 | 2.00 | 2.00 | 2.00 |
| Suds Suppreser | 0.30 | 0.50 | — | 0.30 | 0.3 | — |
| Dow BF 20 | | | | | | |
| Suds Suppreser | — | — | 0.50 | — | — | 0.50 |
| Wacker SE 39 | | | | | | |

Suds height performance (mm)

| | | | | | | |
|---|---|---|---|---|---|---|
| Tap water | 17 | 6 | 7 | 10 | 15 | 5 |
| Water from | 22 | 13 | 5 | 30 | 25 | 5 |
| wax soln | | | | | | |

Mother benefit of the invention is the surprising stability of the SLS resulted by formulating using a buffered region around the pKa of the citric acid. This will increase the long term microbial activity of the formulation making a low acid SLS containing formulation manufacturing feasible. The following table compares the stability of a buffered formulation versus non buffered formulation. The SLS activity was determined by Cat SO3.

| | | | | Remaining |
|---|---|---|---|---|
| Sample | Theoretical | Initial | 2 wks 120 F. | Activity |
| 4.3% SLS | 1.19 | 1.13 | 1.12 | 94% |
| Buffered | | | | |
| Composition | | | | |
| 0.6% SLS Not | 0.19 | 0.148 | 0.018 | 9.4% |
| Buffered | | | | |

What is claimed is:

1. A composition for cleaning fruits, vegetables and meats at an acidic pH, comprising:
(a) from about 0.4% to about 6%, by weight of an anionic surfactant;
(b) from about 0.01% to about 5%, by weight of a polysorbate;
(c) from about 0.01% to about 1%, by weight of a silicone containing suds suppreser;
(d); from about 10% to about 50%, by weight of organic polycarboxylic acid; and
(e) an aqueous carrier;
wherein said composition has a toxicologically-acceptable acidic buffer.

2. A composition according to claim 1, wherein the anionic surfactant is Sodium Lauryl Sulfate.

3. A composition according to claim 1, wherein the silicone containing suds suppreser is selected from the group comprising of Dow DC-10 or Dow DC BF 20, or Wacker SE 39 or Wacker SE 90 and the combination thereof.

4. A composition according to claim 1, wherein the polysorbate is selected from the group comprising of polysorbate, 80, 81, 60, 40, and 20 and the combination thereof.

5. A composition according to claim 1, wherein the organic polycarboxylic acid is citric acid.

6. A composition according to claim 1, which also comprising a sorbitant.

7. A composition according to claim 6, wherein the sorbitant is selected from the group comprising of sorbitant, 20, or 60 and the combination thereof.

8. A composition for cleaning fruits, vegetables and meats at an acidic pH, comprising:
(a) from about 0.4% to about 6%, by weight of Sodium Lauryl Sulfate;
(b) from about 0.01% to about 5%, by weight of a polysorbate;
(c) from about 10% to about 50%, by weight of citric acid;
(d) optionally, a toxicologically-acceptable acidic buffer;
(e) optionally, a toxicologically-acceptable preservative; and
(f) the balance comprising an aqueous carrier;
wherein said composition has a toxicologically-acceptable acidic buffer pH in the range of from about 2.3 to 2.6.

9. A concentrated composition suitable for use with impure water in preparing a dilute treatment composition having a viscosity of less than about 10 cp for treating food at a acid pH by diluting with said impure water using from about 0.1% to about 5% of the concentrated composition, by weight of the dilute treatment composition, said concentrated composition comprising:
(a) from about 0.4% to about 6% by weight of toxicologically-acceptable detergent surfactant selected from the group consisting of alkyl sulfates;
(b) a acid buffer to provide a pH in said dilute treatment composition of from about 2.9 to about 3.1, but with low reserve acidity in said dilute composition to avoid damage to a human;
(c) from about 0.5% to about 5%, by weight of a polysorbate;
(d) a toxicologically-acceptable suds suppressor; and
(e) the balance comprising compatible, toxicologically-acceptable inert and/or minor ingredients, said composition being packaged in combination with usage instructions which instruct the user regarding dilution and timing of useage of said composition, as well as directing the user not to rinse the composition from the food to avoid possible recontamination, wherein said timing of useage comprises contacting said food with said dilute treatment composition for a period of time in excess of one half minute.

10. A acid treating solution comprising:
(a) an anionic surfactant;
(b) a polysorbate;
(c) a silicone containing suds suppreser; and
(d) the balance comprising an aqueous carrier;
wherein the suds suppression benefits is achieved by the combination of a silicone containing suds suppresser in combination with a polysorbate, wherein the solution is used to treat/clean other non-food inanimate household surfaces, such as fabrics, e.g., clothing, shoes, and shower curtains, especially those that are used by infants, especially toys, diapers (napkins), and bibs, wherein said composition has a toxicologically-acceptable acidic buffer.
